(19) United States
(12) Patent Application Publication
(10) Pub. No.: US 2007/0225871 A1
(43) Pub. Date: Sep. 27, 2007

(54) Managing predictable thermal environments

(76) Inventor: Christopher K. Karstens, Apex, NC (US)

Correspondence Address: MARCIA L. DOUBET LAW FIRM, P.O. BOX 422859, KISSIMMEE, FL, 34742-2589, US

(21) Appl. No.: 11/388,401

(22) Filed: Mar. 24, 2006

(51) Int. Cl. G05D 23/00

(52) U.S. Cl. 700/299; 700/276

(57) ABSTRACT

Managing predictable thermal environments for equipment in a proactive manner. Short and/or long term predictors of impending temperature change are defined. Predictors may comprise physical acts, pattern recognition, job scheduling, and so forth. For each predictor, at least one action to be taken upon occurrence of the predictor is defined. Actions preferably comprise initiating heating or cooling systems, as appropriate for the associated equipment. The predictors are monitored, and upon occurrence of a predictor, the defined action is taken. In one aspect, the proactive thermal environment management is self-tuning, whereby one or more actions may be modified. Optionally, this aspect may further comprise self-tuning of predictors.

### BACKGROUND OF THE INVENTION

The present invention relates generally to physical equipment, and more particularly to proactively managing the predictable thermal environments of such equipment.

Equipment that requires cooling (or heating, alternatively) for proper operation often relies on temperature sensors and predefined temperature thresholds to manage the equipment's thermal environment. For example, if the temperature of a computer central processing unit (“CPU”) rises to a particular threshold, the equipment may be adapted to increase the fan speed. Or, if the temperature of a refrigerator rises to a threshold, it may be adapted for turning on the compressor. And if engine coolant of an automobile rises to a threshold, it may be adapted to turn on the radiator fan. For equipment that requires some minimal temperature, such as may be used (for example) in curing during a manufacturing process, the equipment may be adapted to turning on a heating element if a heat loss occurs and the temperature drops below a threshold. These are reactive approaches, where the equipment is reacting to a particular component going outside the threshold for its ideal, desired temperature.

### BRIEF SUMMARY OF THE INVENTION

In one aspect, the present invention provides an automated method for managing predictable thermal environments, comprising steps of: detecting occurrence of any of at least one defined predictors or defined predictors set that each comprise a plurality of defined predictors, wherein each defined predictor or defined predictor set corresponds to impending temperature change of an associated device and has associated therewith at least one defined action to be taken, upon detecting the occurrence of the predictor or the predictor set, to address the impending temperature change; and initiating each of the defined actions associated with each detected occurrence.

In another aspect, the present invention provides a proactive thermal environment management system, comprising: detecting means for detecting occurrence of any of at least one predictors or defined predictor sets that each comprise a plurality of defined predictors, wherein each defined predictor or defined predictor set corresponds to impending temperature change of an associated device and has associated therewith at least one defined action to be taken, upon detecting the occurrence of the predictor or the predictor set, to address the impending temperature change; and initiating means for initiating each of the defined actions associated with each detected occurrence.

In yet another aspect, the present invention provides a computer program product for proactively managing thermal environments, the computer program product comprising at least one computer-usable media storing computer-readable program code, wherein the computer-readable program code, when executed on a computer, causes the computer to: detect occurrence of any of at least one predictors or defined predictor sets that each comprise a plurality of defined predictors, wherein each defined predictor or defined predictor set corresponds to impending temperature change of an associated device and has associated therewith at least one defined action to be taken, upon detecting the occurrence of the predictor, to address the impending temperature change; and initiate each of the defined actions associated with each detected occurrence.

These aspects may further comprise observing results, within a particular time period, of at least one initiated action; and adjusting the defined action, for at least one of the observed results, responsive to determining that the at least one observed results are not anticipated results of the initiated action. Alternatively, the predictor or predictor set with which the initiated action is associated may be adjusted. The defined actions for the aspects may comprise activating a cooling component, or a heating component, for the device to which the action corresponds. The defined predictors may comprise: occurrence of a physical act that impacts device temperature of the corresponding device; occurrence of job scheduling for a job that is known to impact device temperature of the corresponding device; recognition of a pattern that impacts device temperature of the corresponding device; reaching a particular time of day; and/or a current temperature, for the device associated with the defined predictor, reaching a particular value.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined by the appended claims, will become apparent in the non-limiting detailed description set forth below.

The present invention will be described with reference to the following drawings, in which like reference numbers denote the same element throughout.

### BRIEF DESCRIPTION OF THE SEVERAL VIEWS OF THE DRAWINGS

FIG. 1 provides a flowchart depicting logic which may be used when configuring a system according to preferred embodiments;

FIG. 2 provides a table to illustrate sample configuration information for a hypothetical thermal environment management system;

FIGS. 3 and 4 provide flowcharts depicting logic which may be used when implementing proactive thermal environment management according to aspects of the present invention;

FIG. 5 depicts a data processing system suitable for storing and/or executing program code; and

FIG. 6 depicts a representative networking environment in which one or more embodiments of the present invention may be used.

### DETAILED DESCRIPTION OF THE INVENTION

Preferred embodiments of the present invention are directed toward managing predictable thermal environments in a proactive manner. When using prior art reactive approaches for equipment for which an ideal temperature is some value “y” degrees, it may be that some deviation “−x” degrees from this ideal temperature is acceptable, whereas a deviation “+x” degrees may mean product failure, dangerous conditions, or excessive product wear. Or conversely, in a scenario where a minimum temperature is required, a deviation of “+z” degrees may be acceptable, whereas a deviation of “−z” degrees is not. Examples of these adverse results include CPU failure, food spoilage, failure of a product to cure during manufacturing, and degradation or eventual stopping of an engine.

According to preferred embodiments, a proactive approach is used, whereby short and/or long term predictors are used to manage thermal environments. Potential benefits of this proactive approach include reducing “reactive” energy costs and wear on the equipment. (The terms “equipment” and “device” are used interchangeably herein.)

Preferred embodiments are discussed herein with reference to devices including computers, CPUs, refrigerators, and automobile engines, although these devices are used by way of illustration and not of limitation.

One approach to using predictors for managing thermal environments, according to embodiments of the invention, involves physical acts. Another approach involves pattern recognition or job scheduling for patterns or jobs, respectively, that are known to impact device temperature. Scenarios using these predictors will now be described.

Physical acts may operate as predictors of impending temperature change (where this temperature change may occur relatively soon following the physical act, such that the physical act may be considered a short-term predictor). As an example of using physical acts as predictors for managing thermal environments of devices, suppose the device is a refrigerator. Opening the refrigerator door typically causes the inside temperature to rise. As another example scenario, removing thermally-sensitive parts from a computer may alter the computer's temperature. As yet another example, opening the door of a curing chamber in a manufacturing process may cause sufficient heat loss that the chamber's interior temperature decreases. In some cases, the temperature may take a minute or two (or perhaps more) to change and to trigger the prior-art temperature sensor threshold.

For example, if the room temperature is 80 degrees Fahrenheit and the temperature inside a refrigerator is 45 degrees, and the refrigerator door is opened for 30 seconds, it may be known that the compressor will trip on in 2 minutes to bring the temperature back down to the ideal temperature when using a prior art reactive approach.

According to preferred embodiments, such physical acts as opening the refrigerator door can be detected, and the proactive thermal environment management disclosed herein can be invoked without waiting until the temperature changes enough to trigger the temperature sensor that controls the compressor. Instead, the compressor can be proactively turned on upon detecting the physical act of opening the door, or perhaps upon detecting that the door has remained open for a particular length of time. Similarly, for other types of equipment, predictions can be made about what will happen to the equipment's temperature over a particular time interval, and techniques disclosed herein can be used to proactively manage the equipment's thermal environment.

Pattern recognition or job scheduling may operate as predictors of impending temperature change (where this temperature change may occur a relatively long time following recognition of the pattern or the scheduled job, such that the pattern recognition of a particular pattern or job scheduling of a particular job may be considered a long-term predictor). Payroll processing and peak service usage are two examples of predictable software load on a computing environment that for which the thermal environment may be proactively managed using techniques disclosed herein, as will now be described in more detail.

As an example job scheduling scenario, suppose that payroll processing is a scheduled job that is always scheduled to begin on Saturday night at 9:00 p.m. Eastern Standard Time (“EST”), and that the processing typically runs until 11:00 p.m. EST.

As an example pattern recognition scenario, suppose that a high number of people check a particular traffic-oriented web page as they are getting ready to leave work at 5:00 p.m. EST. The servers that provide the traffic-oriented web page may be relatively idle until just before 5:00 p.m., and may then operate at nearly 100 percent capacity for a predictable time period (such as one hour).

In these operating scenarios, when the servers are relatively idle, they may be operating at ideal temperatures with, for example, low fan speeds. However, when the processing load increases, the CPUs, memory, and hard drives are all activated, which causes component temperature to rise. In a reactive approach, cooling systems comprising fans and blowers must increase operations accordingly to bring the temperature back down to the ideal operating temperature. Using techniques disclosed herein, component temperatures may be lowered in anticipation of the impending processing load (as will be discussed in more detail).

In another pattern recognition scenario, suppose it is determined that a family opens their refrigerator door several times between 8:00 a.m. and 9:00 a.m. for breakfast, and then again several times between 6:00 p.m. and 7:00 p.m. for dinner. The refrigerator temperature is affected by the door openings, and using techniques disclosed herein, can be proactively managed.

Preferred embodiments adopt a proactive approach to managing thermal environments and thus begin changing the temperature of the equipment before the scheduled job or pattern recognition event occurs. Similarly, upon detecting a particular physical act that is likely to result in equipment temperature moving away from the ideal, proactive management can be used to address the temperature. As a result of these proactive approaches, the component temperature may never exceed the ideal operating temperature in a scenario where the equipment requires cooling, and may not go below the ideal operating temperature in a scenario where the equipment requires heating. Instead, preferred embodiments adjust the temperature gradually, upon occurrence of a short-term or long-term predictor, before the temperature changes as a result of the predictor (or before a significant predictor-instigated change, depending on the particular predictor). For example, upon detecting that the physical act involved in a short-term predictor has occurred, and upon occurrence of a long-term predictor such as anticipation of a scheduled job or recognized pattern, preferred embodiments may begin to lower the device's temperature to ensure that the device does not overheat as a result of the predicted act or pattern (or, alternatively, preferred embodiments may begin to raise the device's temperature in scenarios where it is desirable to ensure that the act or pattern does not result in a temperature that is too low).

In this manner, energy costs may be lower than experienced for the more-aggressive cooling (or heating, alternatively) that is required with the prior art reactive approach of bringing a device's temperature back into a safe operational temperature zone after an overheating event (or an event that allows too much heat loss, respectively). Furthermore, keeping the equipment temperature within the appropriate threshold, according to preferred embodiments, is expected to be easier on the equipment and minimize wear (or food spoilage and so forth), as contrasted to the prior art approach of allowing the equipment to temporarily overheat (or to be temporarily too cool, in heat loss scenarios).

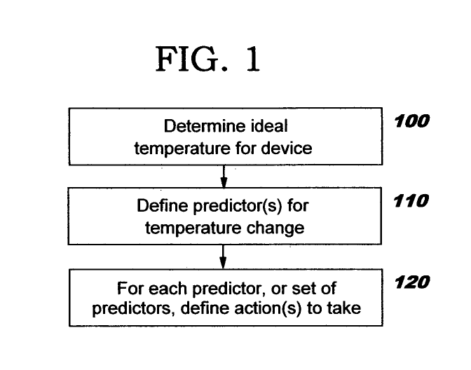

Referring now to FIG. 1, a flowchart is provided that depicts logic which may be used when configuring a system for thermal environment management according to preferred embodiments. As shown therein, an ideal temperature is preferably defined (Block 100) for each device of interest. (Note that the “ideal” temperature used in the thermal environment management may be different from the ideal operating temperature of a device. The “ideal” temperature for thermal environment management purposes may be viewed as a “goal” temperature for the device.) For example, an ideal temperature for a monitored refrigerator might be 45 degrees.

One or more predictors of impending temperature change are defined (Block 110) for each device of interest. In the monitored refrigerator scenario, for example, a predictor based on physical actions may be that the refrigerator door has been open for more than 30 seconds while the inside temperature is more than 42 degrees. In a heat loss scenario, such as monitoring the temperature of a baking oven, a predictor based on physical actions may be that the oven door has been open for more than 45 seconds while the inside temperature is less than or equal to 350 degrees. Predictors may be defined as individually predicting a temperature change, or a set of predictors may be defined, whereby the temperature change in this latter case is predicted only when all of the predictors in the set occur.

For each predictor or set of predictors, an action or actions to be taken to proactively address the impending temperature change, upon occurrence of the predictor, is/are defined (Block 120). (References herein to “a predictor” occurring and to taking “an action” are to be interpreted as also including scenarios where a defined set of predictors occurs and where a defined set of actions is to be taken.) Referring again to the monitored refrigerator scenario, an action to be taken might be to turn on the compressor for 1 minute; for the monitored baking oven scenario, an action to be taken might be to turn on the heating element for 1 minute.

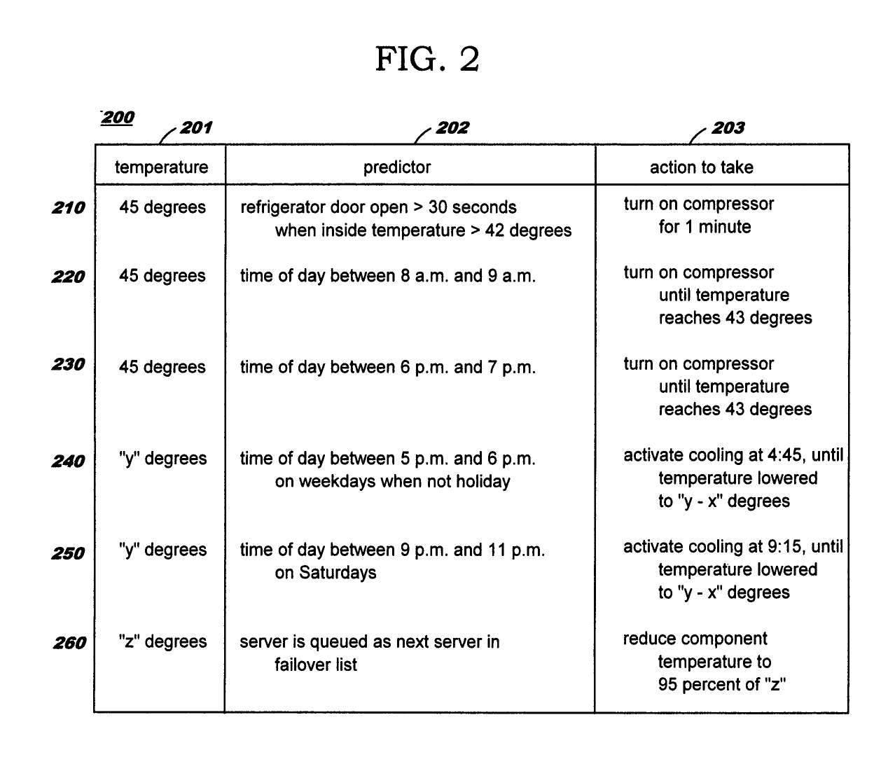

FIG. 2 provides a table 200 to illustrate sample configuration information for a hypothetical thermal environment management system for which the monitored devices comprise a refrigerator (see reference numbers 210-230) and a computer system (see reference numbers 240-260). The row at reference number 210 corresponds to the above-described scenario where an ideal temperature 201 for the refrigerator is determined, at Block 100 of FIG. 1, to be 45 degrees; a predictor 202 is defined for the open-door scenario as discussed with reference to Block 110; and an action 203 to be taken upon occurrence of the predictor is defined as discussed with reference to Block 120.

The rows at reference numbers 220 and 230 provide two additional hypothetical predictors for the monitored refrigerator, and correspond to the previously-discussed scenario where a family tends to open the refrigerator door repeatedly between 8 a.m. and 9 a.m. (row 220) and also between 6 p.m. and 7 p.m. (row 230). For these predictors, table 200 indicates that the action to be taken (see column 203) is to turn on the compressor until the inside temperature of the refrigerator reaches 43 degrees.

The rows at reference numbers 240 and 250 correspond, in this hypothetical example, to a monitored computer system for which an ideal temperature is some number “y” degrees (as shown in column 201). The first predictor (row 240) for this monitored computer system is that the time of day is between 5 p.m. and 6 p.m. on weekdays which are not a holiday. See column 202. This predictor corresponds to the above-discussed scenario where a large number of people access a traffic-oriented web page before leaving work, which (in this illustrative scenario) is identified as causing CPU temperature to rise. The second predictor (row 250) for this monitored computer system is that the time of day is between 9 p.m. and 11 p.m. on Saturdays. This predictor corresponds to the above-discussed scenario where payroll processing is performed on Saturday nights, which also (in the illustrative scenario) causes CPU temperature to rise. For both of these predictors, the defined action to be taken in this hypothetical system is to activate a cooling system (e.g., by turning on the fan and/or a water-cooled or refrigerant-based component) until the CPU temperature has been lowered to some number “y-x” degrees (see column 203). This enables the thermal environment of the CPU to be proactively “primed”, such that its temperature is reduced below its current (idle-state) temperature in anticipation of receiving a full workload. In these hypothetical examples, the lowering of the temperature is to begin at 4:45 p.m. for the action corresponding to the predictor in row 240, while for the action corresponding to the predictor in row 250, the lowering of the temperature is to begin at 9:15 p.m. (In actual operation, a number of factors may contribute to determining when the priming of the temperature should begin, including how long it takes for the temperature to be adjusted, the type of equipment and type of heating or cooling apparatus used for that equipment, the impact of the predictor on the temperature, and so forth.)

The row at reference number 260 corresponds, in this hypothetical example, to a monitored computer system for which an ideal temperature is some number “z” degrees. (It should be noted that the computer system to which the predictor in row 260 applies may be distinct from the one to which rows 240 and 250 correspond.) The proactive temperature control in this case corresponds to a form of job scheduling that is represented by queuing, and in this particular example, the job scheduling is queuing of servers in a failover list. The predictor for this example is that a particular monitored server is queued as the next server to be chosen in the failover list. (As an alternative example, the predictor might be that the server is queued in one of the top 2 locations, or perhaps within the top “N” locations, on the queue.) The action specified in row 260 (see column 203) is to reduce component temperature to 95 percent of “z”. This enables the server to begin proactively priming its thermal environment, such that its component temperature is reduced below its current (idle-state) temperature in anticipation of receiving a full workload from a failed server.

As will be obvious from the teachings disclosed herein, table 200 is merely illustrative of how the configuration information for monitored equipment in a thermal environment management system may be stored. An actual thermal environment management system may comprise configuration information for many devices, and each of these devices might having varying numbers of predictors. Embodiments of the present invention may also be used for thermal environment management of a single device, and such embodiments are within the scope of the present invention. Furthermore, the particular temperatures, predictors, and actions illustrated in FIG. 2 are by way of illustration and not of limitation. (While not illustrated in FIG. 2, predictors corresponding to heat loss scenarios such as the monitored baking oven and curing chamber examples discussed above preferably use an analogous approach to that which is depicted.)

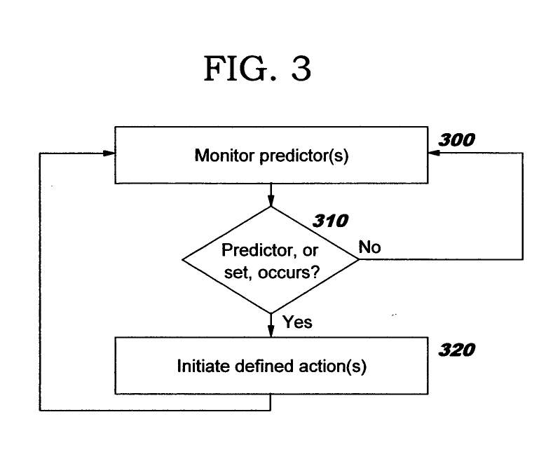

Turning now to FIG. 3, a flowchart is provided depicting logic that may be used when implementing proactive thermal environment management according to one aspect of the present invention. As shown therein, one or more predictors are monitored (Block 300). Note that the particular type of monitoring performed at Block 300 may vary. In some scenarios, the actual device itself is monitored. For example, in the scenario represented by row 210 of FIG. 2, a refrigerator is monitored to determine whether its door is open, and the internal temperature is also monitored in this illustrative scenario. In other scenarios, the monitoring may not involve the actual device. For example, in the scenarios represented by rows 220-230 of FIG. 2, the time of day is monitored as a predictor for the device.

Referring again to FIG. 3, when a defined predictor occurs (or a defined set of predictors occurs), the test at Block 310 has a positive result, and control transfers to Block 320 where the defined action (or the defined set of actions) for that predictor (or set of predictors) is then initiated. For the scenario represented by row 210 of FIG. 2, for example, the action performed in Block 320 is turning on the refrigerator's compressor for 1 minute.

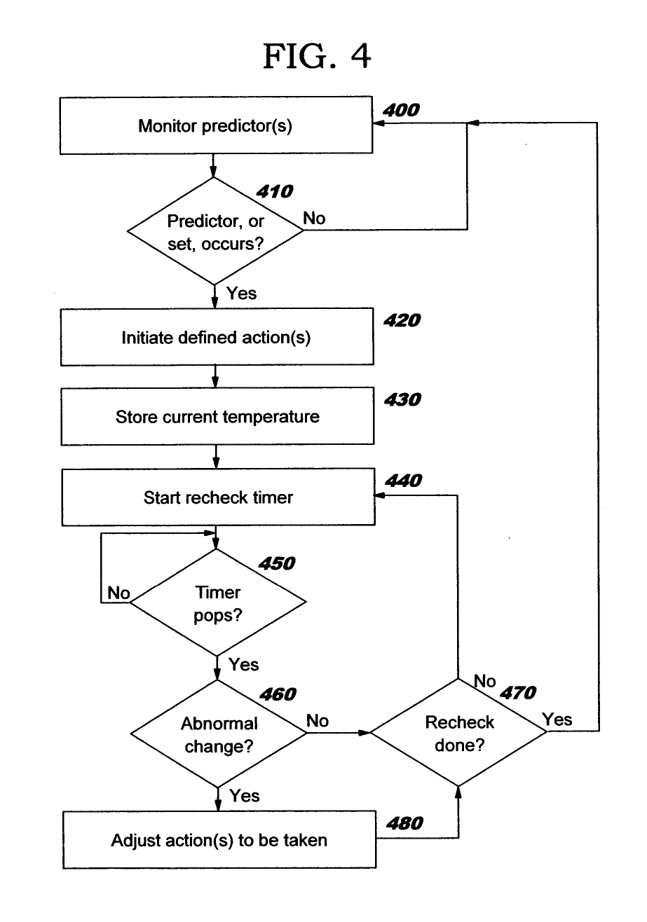

In another aspect of the present invention, the proactive thermal environment management is self-tuning. FIG. 4 provides a flowchart depicting logic that may be used when implementing proactive thermal environment management according to this aspect. Blocks 400-420 correspond generally to Block 300-320 of FIG. 3. In this aspect, once the defined action (or set of actions) is initiated at Block 420, the self-tuning mechanism begins by storing the current temperature of the monitored device (Block 430). A recheck timer is started (Block 440), where this timer is used to recheck the device temperature after some elapsed period of time (i.e., after the timer has popped). Preferably, the timer length corresponds to the predictor that has occurred (and may be configurable for each predictor).

Accordingly, Block 450 checks to see if the recheck timer has popped. If not, the self-tuning process continues to wait. Once the timer has popped, the test at Block 450 has a positive result, and processing continues at Block 460.

Block 460 represents checking the now-current temperature of the device, and comparing that temperature to an expected temperature change in the device's ideal temperature to determine whether the actual temperature change is abnormal. For example, suppose the recheck timer is set to expire in 5 minutes, and that the expected temperature change within this time interval is 0.5 degrees; however, further suppose that the temperature has changed by 1 degree within this time interval. This may be an indication that the action taken at Block 420 was not aggressive enough. Suppose, for example, that the ideal temperature for a monitored refrigerator is 45 degrees, and that the expected result of turning on the refrigerator's compressor for 1 minute upon occurrence of the trigger in row 210 of FIG. 2 is that the temperature would be lowered to 43 degrees. In this example, the test at Block 460 corresponds to checking whether the current temperature inside the refrigerator is more than 43 degrees. If so, then the action taken to control the refrigerator's temperature is not working to control the temperature as expected.

Accordingly, in this self-tuning aspect, adjustment can be made to the action (or set of actions) that is to be taken when this particular predictor (or set of predictors) occurs (Block 480). In the scenario represented by row 210 of FIG. 2, for example, the action in column 203 might be modified to “turn on compressor for 2 minutes”. As another example, in the scenario represented by row 220 of FIG. 2, the action in column 203 might be modified to “turn on compressor until temperature reaches 42 degrees”. This self-tuning might be triggered, for example, if the family holds the refrigerator door open for longer periods of time than were anticipated when defining the action in row 220, or perhaps because the room temperature is higher than was anticipated.

As yet another example of self-tuning, suppose the predictor that occurred was detecting that the time of day has reached 9 p.m., indicating that payroll processing is about to begin, and that the action taken was to activate a cooling system until the temperature reached “y−x”degrees (as reflected in row 250 of FIG. 2). If the test at Block 460 determines that the current temperature is higher than expected after the cooling system has been activated for the interval represented by the recheck timer, the self-tuning might comprise activating the cooling system at 8:45 p.m. instead of 9:15 p.m.; or, the self-tuning might comprise changing the action in column 203 such that the temperature is lowered to “y−(x+1)” degrees, instead of to “y−x” degrees, on the next detection of this predictor. And, the self-tuning may continue to recheck throughout the 2-hour interval corresponding to this predictor 250, such that ongoing temperature corrections may be made. Furthermore, additional tuning of the predictor may be performed, such that the periodic checking provides information usable in determining (for example) how much the temperature should be changed to enable the monitored device to stay within its temperature threshold.

Self-tuning adjustment may be made manually and/or programmatically without deviating from the scope of the present invention. Accordingly, Block 480 may comprise generating an operator alert, writing a message into a log file, programmatically updating an entry in data structure 200, and so forth. Following operation of Block 480, and when the test in Block 460 has a negative result, Block 470 tests to see if the rechecking (i.e., the self-tuning of the predictor for which occurrence was detected at Block 410) is finished. If so, then control preferably transfers back to Block 400 to continue monitoring one or more predictors. When the test at Block 470 has a negative result, indicating that the self-tuning should continue for this predictor, control returns to Block 440, where the recheck timer is restarted.

In a further enhancement, an embodiment of the present invention may detect when a predictor occurs and/or when the self-tuning aspect determines that the predictor should be modified. For example, in the predictor represented in row 240 of FIG. 2, it might be determined that the heavy web usage does not actually begin at 5 p.m. and continue until 6 p.m., but instead is concentrated between 5:15 p.m. and 5:45 p.m. The predictor may then be modified accordingly.

The manner in which a component's temperature is controlled may vary, depending on the component. For example, a refrigerator's temperature may be controlled by turning on its compressor, whereas a CPU temperature may be controlled by activating a cooling system (comprising, for example, a fan, water-cooled and/or refrigerant-based components, and so forth). Messages that trigger these elements to turn on are preferably sent to device/component controllers, according to the proactive thermal environment management described herein, using prior art message transmission techniques. The manner in which those messages are handled upon receipt at the device/component controllers does not form part of the inventive techniques disclosed herein.

As will be appreciated by one of skill in the art, embodiments of the present invention may be provided as methods, systems, and/or computer program products comprising computer-readable program code. Accordingly, the present invention may take the form of an entirely software embodiment, an entirely hardware embodiment, or an embodiment combining software and hardware aspects. In a preferred embodiment, the invention is implemented in software, which includes (but is not limited to) firmware, resident software, microcode, etc.

Furthermore, embodiments of the invention may take the form of a computer program product accessible from computer-usable or computer-readable media providing program code for use by, or in connection with, a computer or any instruction execution system. For purposes of this description, a computer-usable or computer-readable medium may be any apparatus that can contain, store, communicate, propagate, or transport a program for use by, or in connection with, an instruction execution system, apparatus, or device.

The medium may be an electronic, magnetic, optical, electromagnetic, infrared, or semiconductor system (or apparatus or device) or a propagation medium. Examples of a computer-readable medium include a semiconductor or solid state memory, magnetic tape, removable computer diskette, random access memory (“RAM”), read-only memory (“ROM”), rigid magnetic disk, and optical disk. Current examples of optical disks include compact disk with read-only memory (“CD-ROM”), compact disk with read/write (“CD-R/W”), and DVD.

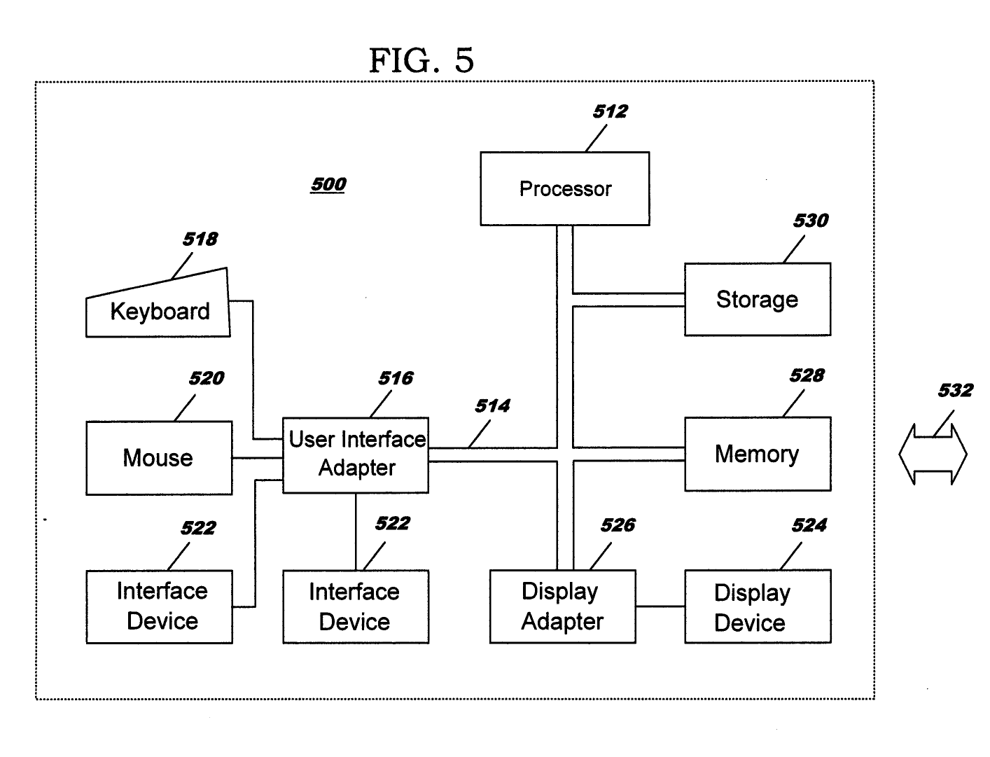

Referring now to FIG. 5, a data processing system 500 suitable for storing and/or executing program code includes at least one processor 512 coupled directly or indirectly to memory elements through a system bus 514. The memory elements may include local memory 528 employed during actual execution of the program code, bulk storage 530, and cache memories (not shown) which provide temporary storage of at least some program code in order to reduce the number of times code must be retrieved from bulk storage during execution.

Input/output (I/O”) devices (including but not limited to keyboards 518, displays 524, pointing devices 520, other interface devices 522, etc.) can be coupled to the system either directly or through intervening I/O controllers or adapters (516, 526).

Network adapters may also be coupled to the system to enable the data processing system to become coupled to other data processing systems or remote printers or storage devices through intervening private or public networks (as shown generally at 532). Modems, cable modem attachments, wireless adapters, and Ethernet cards are just a few of the currently-available types of network adapters. Furthermore, a network adapter may be used to enable the data processing system to be coupled to a monitored device (or devices).

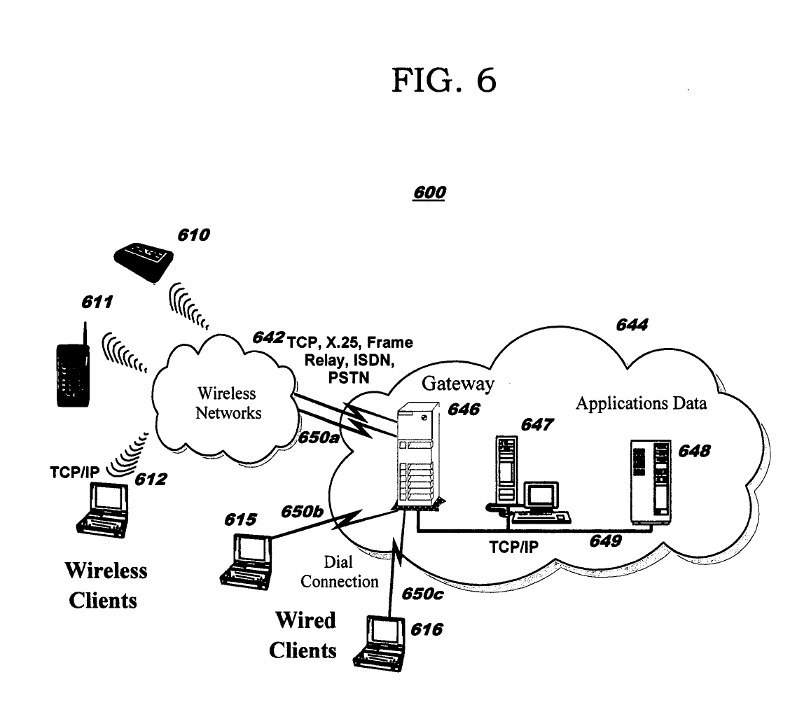

FIG. 6 illustrates a data processing network environment 600 in which the present invention may be practiced. (It should be noted, however, that the scope of the present invention is not limited to embodiments provided in a networking environment.) The data processing network 600 may include a plurality of individual networks, such as wireless network 642 and network 644. A plurality of wireless devices 610, 611, 612 may communicate over wireless network 642, and a plurality of wired devices, shown in the figure (by way of illustration) as workstations 615, 616, may communicate over network 644. Additionally, as those skilled in the art will appreciate, one or more local area networks (“LANs”) may be included (not shown), where a LAN may comprise a plurality of devices coupled to a host processor.

Still referring to FIG. 6, the networks 642 and 644 may also include mainframe computers or servers, such as a gateway computer 646 or application server 647 (which may access a data repository 648). A gateway computer 646 serves as a point of entry into each network, such as network 644. The gateway 646 may be preferably coupled to another network 642 by means of a communications link 650a. The gateway 646 may also be directly coupled to one or more workstations 615, 616 using a communications link 650b, 650c, and/or may be indirectly coupled to such devices. The gateway computer 646 may be implemented utilizing an Enterprise Systems Architecture/370™ available from the International Business Machines Corporation (“IBM®”), an Enterprise Systems Architecture/390® computer, etc. Depending on the application, a midrange computer, such as an Application System/400® (also known as an AS/400®) may be employed. (“Enterprise Systems Architecture/370” is a trademark of IBM; “IBM”, “Enterprise Systems Architecture/390”, “Application System/400”, and “AS/400” are registered trademarks of IBM.)

The gateway computer 646 may also be coupled 649 to a storage device (such as data repository 648).

Those skilled in the art will appreciate that the gateway computer 646 may be located a great geographic distance from the network 642, and similarly, the wireless devices 610-612 and/or workstations 615-616 may be located some distance from the networks 642 and 644, respectively. For example, the network 642 may be located in California, while the gateway 646 may be located in Texas, and one or more of the workstations 615-616 may be located in Florida. The wireless devices 610-612 may connect to the wireless network 642 using a networking protocol such as the Transmission Control Protocol/Internet Protocol (“TCP/IP”) over a number of alternative connection media, such as cellular phone, radio frequency networks, satellite networks, etc. The wireless network 642 preferably connects to the gateway 646 using a network connection 650a such as TCP or User Datagram Protocol (“UDP”) over IP, X.25, Frame Relay, Integrated Services Digital Network (“ISDN”), Public Switched Telephone Network (“PSTN”), etc. The workstations 615-616 may connect directly to the gateway 646 using dial connections 650b or 650c. Further, the wireless network 642 and network 644 may connect to one or more other networks (not shown), in an analogous manner to that depicted in FIG. 6.

While preferred embodiments of the present invention have been described, additional variations and modifications in those embodiments may occur to those skilled in the art once they learn of the basic inventive concepts. Therefore, it is intended that the appended claims shall be construed to include preferred embodiments and all such variations and modifications as fall within the spirit and scope of the invention. Furthermore, it should be understood that use of “a” or “an” in the claims is not intended to limit embodiments of the present invention to a singular one of any element thus introduced.

What is claimed is:

1. An automated method for managing predictable thermal environments, comprising steps of:
detecting occurrence of any of at least one defined predictors or defined predictor sets that each comprise a plurality of defined predictors, wherein each defined predictor or defined predictor set corresponds to impending temperature change of an associated device and has associated therewith at least one defined action to be taken, upon detecting the occurrence of the predictor or the predictor set, to address the impending temperature change; and
initiating each of the defined actions associated with each detected occurrence.

2. The method according to claim 1, wherein at least one of the defined actions is to activate a cooling component for the device to which the action corresponds.

3. The method according to claim 1, wherein at least one of the defined actions is to activate a heating component for the device to which the action corresponds.

4. The method according to claim 1, wherein at least one of the defined predictors is occurrence of a physical act that impacts device temperature of the corresponding device.

5. The method according to claim 1, wherein at least one of the defined predictors is occurrence of job scheduling for a job that is known to impact device temperature of the corresponding device.

6. The method according to claim 1, wherein at least one of the defined predictors is recognition of a pattern that impacts device temperature of the corresponding device.

7. The method according to claim 1, wherein at least one of the defined predictors comprises reaching a particular time of day.

8. The method according to claim 1, wherein at least one of the defined predictors comprises a current temperature, for the device associated with the defined predictor, reaching a particular value.

9. The method according to claim 1, further comprising the steps of:
defining at least one of the predictors or the predictor sets of impending temperature change;
defining, for each of the defined predictors or defined predictor sets, the associated at least one action to be taken to address the impending temperature change; and
providing each of the defined predictors or defined predictor sets, and the at least one defined action associated therewith, to a thermal environment management system that is adapted for carrying out the detecting and initiating steps.

10. A proactive thermal environment management system, comprising:
detecting means for detecting occurrence of any of at least one predictors or defined predictor sets that each comprise a plurality of defined predictors, wherein each defined predictor or defined predictor set corresponds to impending temperature change of an associated device and has associated therewith at least one defined action to be taken, upon detecting the occurrence of the predictor or the predictor set, to address the impending temperature change; and
initiating means for initiating each of the defined actions associated with each detected occurrence.

11. The system according to claim 10, wherein each of the predictors or predictor sets and its associated at least one action are persisted in a data structure usable by the detecting means.

12. The system according to claim 10, further comprising:
observing means for observing results, within a particular time period, of at least one initiated action; and
self-tuning means for adjusting the defined action, for at least one of the observed results, responsive to determining that the at least one observed results are not anticipated results of the initiated action.

13. The system according to claim 12, wherein the self-tuning means further comprise means for programmatically adjusting the defined action.

14. The system according to claim 12, wherein the self-tuning means provide information usable by a human in adjusting the defined action.

15. The system according to claim 10, further comprising:
observing means for observing results, within a particular time period, of at least one initiated action; and
self-tuning means for adjusting the predictor or predictor set with which the initiated action is associated, for at least one of the observed results, responsive to determining that the at least one observed results are not anticipated results of the initiated action.

16. The system according to claim 10, further comprising:
first defining means for defining at least one the predictors or the predictor sets of impending temperature change;
second defining means for defining, for each of the defined predictors or defined predictor sets, the associated at least one action to be taken to address the impending temperature change; and
providing means for providing each of the defined predictors or defined predictor sets, and at least one defined action associated therewith, to the proactive thermal environment management system.

17. A computer program product for proactively managing thermal environments, the computer program product comprising at least one computer-usable media storing computer-readable program code, wherein the computer-readable program code, when executed on a computer, causes the computer to:
detect occurrence of any of at least one predictors or defined predictor sets that each comprise a plurality of defined predictors, wherein each defined predictor or defined predictor set corresponds to impending temperature change of an associated device and has associated therewith at least one defined action to be taken, upon detecting the occurrence of the predictor or the predictor set, to address the impending temperature change; and
initiate each of the defined actions associated with each detected occurrence.

18. The computer program product according to claim 17, wherein the computer-readable program code further causes the computer to:
observe results, within a particular time period, of at least one initiated action; and
for each of the observed results, adjust the defined action, responsive to determining that the observed results are not anticipated results of the initiated action.
